(19) United States
(12) Patent Application Publication
(10) Pub. No.: US 2026/0347144 A1
(43) Pub. Date: Nov. 5, 2026

(54) INTERACTIVE PANELS FOR AN ELEVATOR UNIT

(71) Applicant: INVENTIO AG, Hergiswil (CH)

(72) Inventors: Varsha Trivedi, Pune Maharashtra (IN); Romeo Lo Jacono, Gravesano (CH); Antonio Perfetto, Ebikon (CH); Narayan Sangale; Vrushali Deshmukhe, Sangli (IN); Deepak Varma, Pune Maharashtrav (IN)

(21) Appl. No.: 19/487,285

(22) PCT Filed: Jun. 17, 2024
(86) PCT No.: PCT/EP2024/066806

§ 371 Date: Nov. 24, 2025

(30) Foreign Application Priority Data
Jun. 20, 2023 (EP) 23180240.6

(51) Int. Cl. B66B 1/46

(52) U.S. Cl. CPC B66B 1/468; B66B 2201/4623; B66B 2201/4638

(57) ABSTRACT

An interactive panel for an elevator installation unit is disclosed. The interactive panel detects an interaction, triggering at least one call operation signal to operate the elevator installation unit. The interactive panel includes at least one sensing unit and a controller. The at least one sensing unit is configured to transmit a signal. The at least one sensing unit is configured to detect a reflected signal indicative of the radio waves reflected from a foreign object. Further, the at least one sensing unit determines a time duration for which the reflected signal is detected. The at least one sensing unit is configured to compare the determined time duration with a threshold time duration and reject the interaction generated by the reflected signal when the determined time duration is greater than the threshold time duration.

### TECHNICAL FIELD

The present invention relates to elevators and particularly, relates to interactive panels for operating an elevator unit.

### BACKGROUND

Nowadays, elevators are an essential part of multi-story buildings, such as commercial buildings and residential buildings. Generally, elevator units or elevator systems include an elevator car and a counterweight connected to each other via traction ropes or belts. Upon receiving instructions via a lift controller, a drive machine deployed in such an elevator unit moves the traction ropes, thereby moving the elevator car along a pair of guide rails via displacing the counterweight within an elevator shaft of the building. The lift controller may receive such instructions as a result of a user operating an interactive panel. The interactive panel is used to control and operate the elevator unit.

The interactive panel may be classified as a lift operating panel (LOP) or a cabin operative panel (COP). If the interactive panel is located outside the elevator car on each floor, then the interactive panel is referred to as the LOP. In case the interaction panel is disposed inside the elevator car, then the interactive panel is referred to as the COP. Further, such an interactive panel may consist of a set of buttons or touch sensors. The set of buttons or touch sensors may be adapted to allow users to select the floor for landing the elevator car on said selected floor. The interactive panel may also typically include other controls, such as emergency stop buttons and alarm buttons.

The interactive panel communicates with the controller of the elevator unit upon the user providing a touch input and is responsible for moving the elevator car between floors and ensuring to stop the elevator car on the correct floor. The interactive panel may be configured to display information, such as the current floor and a direction of travel, related to the elevator unit.

The interactive panel may come in a variety of designs and configurations, ranging from simple button panels to touch screens with advanced features such as voice announcements and multimedia displays. Modern interactive panels may often feature intuitive interfaces that make them easy to use and may also include accessibility features such as braille or audio guidance for visually impaired users.

While the touch sensors in the interactive panel may be becoming increasingly popular in modern buildings, they do have some drawbacks that should be considered before installing them. For instance, the touch sensors may be highly sensitive, which may be a disadvantage for the interactive panel. Accidentally brushing against the interactive panel or placing an object on the interactive panel could trigger a false activation, leading to unintended stops or other issues. Further, the touch sensors may be vulnerable to wear and tear and may not be as durable as other types of interactive panels. Such vulnerability may result in a shorter lifespan and higher maintenance costs. The touch sensors can be sensitive to extreme temperatures and humidity levels. If installed in the interactive panel outdoors, they may not be able to withstand the elements, leading to malfunction or failure. Additionally, the touch sensors require regular cleaning and maintenance to ensure proper functioning. Dust, dirt, and fingerprints may accumulate on the surface of the touch sensors which may interfere with the sensors' ability to detect touch. Thus, the touch sensors may be more expensive than other types of interactive panels, which may make them less feasible for smaller budgets. Furthermore, some users may find the touch sensors less accessible than traditional buttons, particularly those with disabilities or mobility issues. The lack of tactile feedback may make it difficult for some users to navigate the panel.

While touch sensors in the interactive panel may offer a sleek and modern aesthetic to LOPs or COPs, it's important to consider the above drawbacks before deciding whether to install such touch sensors in the interactive panel.

In order to overcome the drawbacks of the touch sensor interactive panel, several existing techniques provide a touchless sensor installed in the interactive panel.

Currently, the interactive panel with a touchless feature is an innovative device used in the elevator units and other vertical transportation systems that allows passengers to interact with controls in the elevator unit without physical contact. The touchless interactive panel may be designed to reduce the risk of spreading germs and bacteria by eliminating the need for the users to touch potentially contaminated surfaces.

The interactive panel with the touchless feature may be a response to prevent several contagious diseases, which raised concerns about the potential for transmission of the virus through commonly touched surfaces such as the controls of the elevator unit. The touchless interactive panel may use a combination of infrared sensors and motion detection technology to detect the presence of a user's hand and respond to their commands. When a user approaches the touchless interactive panel, the sensors installed in the touchless interactive panel may detect the user's hand movement and thus generate an interaction of the user with the elevator unit. The user can then select their desired instruction or other options using hand gestures, without touching any buttons or surfaces. The touchless interactive panel may also be programmed to provide audible or visual feedback to the user, indicating that their command has been received and processed.

The touchless interactive panel may be a significant advancement for the elevator unit, offering both convenience and safety benefits. In addition to reducing the risk of spreading germs and bacteria, the touchless interactive panel may also be easier to clean and maintain and may be more accessible for individuals with disabilities or mobility impairments.

However, there are instances when the touchless interactive panel may exhibit certain shortcomings. For instance, if the user unintentionally approaches the touchless interactive panel, the elevator unit may receive a false call. In another instance, if the user places a foreign object near the touchless interactive panel, then the false call may keep being generated unless the foreign object is removed. Such false calls may also be a result of sticking the foreign object such as a sticker or chewing gum, on the touchless interactive panel.

Thus, the continuous presence of the foreign object may either continuously generate false calls or hinder the user from providing the instructions to operate the elevator unit.

U.S. Pat. No. 10,968,073B1 describes a touchless keyboard system for operating an elevator through an existing touch-sensitive keyboard of the elevator. The touchless keyboard system includes a touchless detection device comprising a sensor for detecting non-touch indications from users for opted floors, an actuation device for physical engaging buttons of the existing touch-sensitive keyboard of the elevator corresponding to the opted floors, and a controller for receiving and processing output signals from the sensor and controlling movement of the actuator based on the processed output signals. However, the touchless detection device fails to provide techniques to discard or reject the false calls due to the continuous presence of the indications from users.

Therefore, there is a need for an interactive panel that may detect the presence of the foreign object such that a decision may be made to accept or reject the interaction and eliminate the abovementioned associated shortcomings.

### SUMMARY

It is in particular the object of the invention is to provide an interactive panel for an elevator unit. The interactive panel is adapted to detect an interaction for triggering an operation signal to operate the elevator unit. The interactive panel includes a sensing unit in communication with a controller of the elevator unit. The sensing unit is configured to reject the interaction generated as a result of the foreign object present near the sensing unit for more than a determined time duration. According to the invention, this object is solved by the interactive panel having the features of the present disclosure.

The interactive panel for the elevator unit is disclosed in the present invention.

The interactive panel includes at least one sensing unit in communication with a controller of the elevator unit. Further, the at least one sensing unit is configured to transmit a signal, indicative of radio waves. The at least one sensing unit detects a reflected signal reflected from the foreign object. Further, the at least one sensing unit is configured to determine a time duration for which the reflected signal is detected and compare the determined time duration with a threshold time duration. The at least one sensing unit is configured to reject an interaction generated by the reflected signal when the determined time duration is greater than the threshold time.

As mentioned, the interaction generated by the reflected signal is rejected beyond the threshold time. Thus, due to the rejection of the reflected signal, at least one call operation signal generated as a result of the reflected signal is not transmitted to the controller. Thus, rejection of the interaction prevents a false call operation signal, and an elevator car does not receive any instructions to operate. Hence, even if the foreign object is placed in proximity or range of the at least one sensing unit for more than the threshold time duration, the at least one sensing unit may reject the interaction caused by such foreign object. Thereby, the reflected signal from the foreign object will be adsorbed in a reference pattern of the transmitted signal and may not be detected anymore by the at least one sensing unit. Further, it may be advantageous to reject the interaction in case a user attaches the foreign object such as tape, stickers, chewing gum, etc. on the interactive panel for the elevator unit. The at least one sensing unit may be continuously updating a radiation pattern of the transmitted signal similar to a situation when the foreign object is not in front of the at least one sensing unit.

In an embodiment, the at least one sensing unit is configured to detect the reflected signal while the foreign object remains within a predefined distance range of the at least one sensing unit. The predefined distance range (d) may be stored in a memory of the at least one sensing unit.

In an embodiment, the at least one sensing unit is configured to determine a travel time of the reflected signal. The travel time indicates time elapsed in transmitting the signal and detecting the reflected signal. Further, the at least one sensing unit is configured to determine a distance between the object and the sensing unit based on travel time of the reflected signal. The at least one sensing unit is configured to monitor the travel time of the detected reflected signal, while the foreign object remains located at the determined distance for the determined time duration; and reject the interaction generated by the reflected signal if the determined distance remains constant for the determined time duration. Thus, the at least one sensing unit terminates transmission of the at least one call operation signal generated from the continuous presence of the foreign object.

In one or more embodiments, the at least one sensing unit is configured to reject the interaction. The at least one sensing unit is configured to determine an intensity of the detected reflected signal. Further, determine a size of the foreign object based on the determined intensity and reject the interaction generated by the reflected signal if the determined size of the foreign object remains constant for the determined time duration. Thus, the at least one sensing unit terminates transmission of the at least one call operation signal generated from the continuous presence of the foreign object.

In an embodiment, the at least one sensing unit is configured to accept the interaction generated by the reflected signal if the determined time duration is less than the threshold time duration. The interaction triggers the at least one call operation signal indicative of an instruction to perform an associated operation of the elevator unit. Further, the at least one sensing unit is configured to transmit the at least one call operation signal to the controller for performing the associated operation of the elevator unit. Therefore, the at least one sensing unit accepts the interaction and transmits the at least one call operation signal to perform intended operation of the elevator unit. For an instance, the associated operations may include indicating whether the user wants to go up or down in the building, selecting floors for stopping the at least one elevator car on respective floor, opening door of the at least one elevator car, closing door of the at least one elevator car, stopping the at least one elevator car, intercom or telephone.

In an embodiment, at least one detection plane is disposed ahead of the at least one sensing unit. Further, the at least one sensing unit is adapted to trigger the at least one call operation signal in response to the user touching the at least one detection plane. Thus, advantageously the user may interact with the interactive panel using both touch and touchless modes.

In one or more embodiments, the at least one sensing unit includes a pulse coherent radar sensor.

In one or more embodiments, the pulse coherent radar sensor is arranged in a back-panel of the interactive panel such that the at least one sensing unit is not visible to the user.

Therefore, the durability of the pulse coherent radar sensor increases as the interactive panel prevents contact of dust, water, or foreign particles with the pulse coherent radar sensor.

The object mentioned above is solved by an elevator installation unit including at least one interactive panel with the at least one sensing unit. The elevator installation unit includes at least one elevator car coupled to at least one counterweight. The elevator installation unit includes at least one guide rail for guiding the at least one elevator car within an elevator shaft of a building. The elevator installation unit includes a controller for controlling the movement of the elevator car within the elevator shaft of the building. The at least one interactive panel is adapted to control the elevator installation unit according to an embodiment of the disclosure.

The term ‘sensing unit’ refers to a sensor adapted to transmit signal and installed in the at least one interactive panel for detection of the user or the foreign object.

The term ‘foreign object’ refers to any object or material that is not intended to be detected by the sensing unit.

The term ‘controller’ refers to a logic device essential for the elevator unit to operate. The controller monitors the systems, receives instructions from the interactive panel, at least one sensing unit and sends out instructions that manage the different components of the elevator unit.

The term ‘signal’ refers to a radio wave or an electromagnetic wave emitted by the at least one sensing unit.

The term ‘radiation pattern’ refers to distribution or emission of radiations or electromagnetic signals in a direction.

The term ‘intensity” refers to a flux of the signal detected after striking the foreign object.

The term ‘time duration’ refers to a time during which the signal reflected by the foreign object is detected.

The term ‘threshold time duration’ refers to a predefined time during which the signal reflected by the foreign object is detected.

The term ‘detect an interaction’ refers to an identification of the signal reflected by the foreign object.

The term ‘reject an interaction’ refers to ignoring or discarding the presence of the user or any foreign object attempting to provide at least one call operation signal to operate the elevator unit.

The term ‘accept an interaction’ refers to accepting the presence of the user or any foreign object attempting to provide at least one call operation signal to operate the elevator unit.

The term ‘predefined distance range’ refers to a pre-established range of distance that is set or specified in advance for the at least one sensing unit to detect presence of the user or the foreign object.

The term ‘travel time’ refers to the time taken for the signal to travel from sensing unit to the foreign object or the user, bounce off that foreign object or the user, and then return to the at least one sensing unit. Thus ‘travel time’ is the total time it takes for the signal to complete a round trip.

The term ‘back-panel’refers to a rear portion of the interactive panel.

The term ‘associated operation’ refers to various actions such as calling the elevator car, ringing alarm, and lightning option and other procedures involved in the operation and control of the elevator unit.

Additional advantages, features, and details of the invention result using the following description of exemplary embodiments and using drawings in which the same or functionally identical elements are provided having identical reference signs.

### BRIEF DESCRIPTION OF THE DRAWINGS

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

These and other features, aspects, and advantages of the present invention will become better understood when the following detailed description is read with reference to the accompanying drawings in which like characters represent like parts throughout the drawings, wherein:

FIG. 1 illustrates a schematic view of an elevator installation unit, according to an embodiment of the present disclosure;

FIG. 2a illustrates a block diagram of an interactive panel for the elevator installation unit, according to an embodiment of the present disclosure;

FIG. 2b illustrates a block diagram of at least one sensing unit of the interactive panel, according to an embodiment of the present disclosure;

FIGS. 3a and 3b illustrate exemplary views of a lift operating panel (LOP) and cabin operating panel (COP), respectively, according to an embodiment of the present disclosure;

FIG. 4 illustrates an exemplary graphical representation of a radiation pattern of a transmitted signal by the interactive panel of the elevator installation unit, according to an embodiment of the present disclosure; and

FIG. 5 illustrates a flowchart depicting a method for operating the interactive panel of the elevator installation unit, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF EMBODIMENT

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Unless otherwise defined, all technical and scientific terms used herein have the same meaning as commonly understood by one of ordinary skill in the art to which this invention belongs. The system, methods, and examples provided herein are illustrative only and not intended to be limiting.

Any particular and all details set forth herein are used in the context of some embodiments and therefore should NOT be necessarily taken as limiting factors to the attached claims. The attached claims and their legal equivalents can be realized in the context of embodiments other than the ones used as illustrative examples in the description below.

Embodiments of the present invention will be described below in detail with reference to the accompanying drawings.

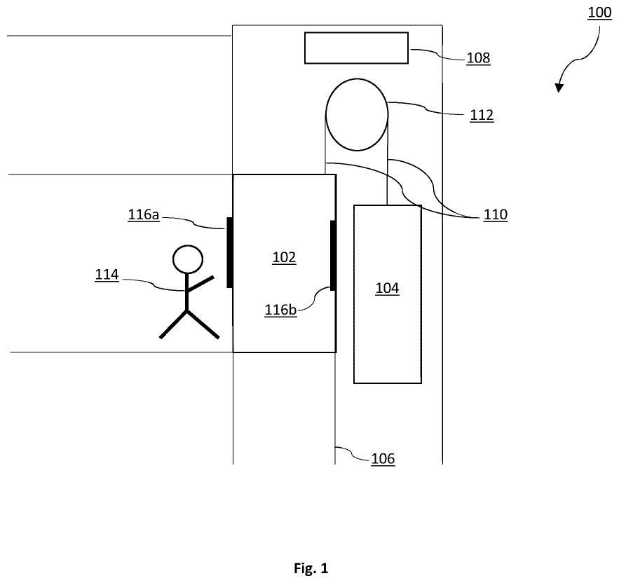

FIG. 1 illustrates a schematic view of an elevator installation unit 100, according to an embodiment of the present disclosure. For the sake of brevity, the elevator installation unit 100 may be alternatively referred to as the elevator unit 100 without departing from the scope of the present invention. The elevator unit 100 may include, but is not limited to, at least one elevator car 102, at least one counterweight 104, at least one guide rail 106, a controller 108, a traction member 110, a drive machine 112, and at least one interactive panel 116. The at least one elevator car 102 may be adapted to be moved within an elevator shaft (not shown) between a plurality of floors of a building. In an embodiment, the least one guide rail 106 may be adapted to guide the at least one elevator car 102 within the elevator shaft of the building. In an embodiment, the at least one counterweight 104 may be adapted to counterbalance a sum of a load of the at least one elevator car 102 and a predetermined load associated with a payload capacity of the at least one elevator car 102.

The at least one elevator car 102 and the counterweight 104 may be coupled to each other via the traction member 110. In an embodiment, the traction member 110 may be embodied as one of a rope and a belt, without departing from the scope of the present invention. Further, the controller 108 may be positioned remotely from the counterweight 104 and the at least one elevator car 102. The controller 108 may be adapted to provide the instruction to perform an associated operation of the elevator unit 100. For instance, the controller 108 may be adapted to provide instructions to the drive machine 112 to control the traction member 110 for moving the at least one elevator car 102 and the counterweight 104.

Further, the elevator unit 100 may include the interactive panel 116 in communication with the controller 108 for performing desired operations of the elevator unit 100. The interactive panel 116 is configured to transmit at least one call operation signal to the controller 108 for performing the associated operation of the elevator unit 100. In an exemplary embodiment, the interactive panel 116 may be a lift operating panel (LOP) 116a or a cabin operating panel (COP) 116b.

For instance, the LOP 116a may be positioned on each floor of the building such that a user 114 may interact with the LOP 116a. An interaction by the user 114 may be accepted by the LOP 116a to further transmit the at least one call operation signal to the controller 108 for performing an upward movement or a downward movement of the at least one elevator car 102.

Further, for instance, the COP 116b may be positioned inside the at least one elevator car 102. Thus, the user 114 while being present in the at least one elevator car 102, may be able to interact with the COP 116b. The interaction by the user 114 may be accepted by the COP 116b, which and further the COP 116b transmits the at least one call operation signal to the controller 108 to perform associated operation of the elevator unit 100.

In an embodiment, the interactive panel 116 may be adapted to detect the interaction indicating of triggering of at least one call operation signal to operate the elevator unit 100. For instance, the interactive panel 116 may include at least one sensing unit 202 adapted to detect and subsequently accept or reject the interaction by the user 114 or a foreign object. The at least one sensing unit 202 may be arranged in a back-panel of the interactive panel 116 such that the at least one sensing unit 202 is not visible to the user 114. For instance, the back-panel may be indicative of a rear portion of the interactive panel 116. In the LOP 116a, the back-panel may be facing towards a wall on the floor of the building such that the at least one sensing unit 202 is not visible to naked eyes of the user 114 interacting with the interactive panel 116. In the COP 116b, the back-panel may be facing towards housing of the at least one elevator car 102 such that the at least one sensing unit 202 is not visible to the naked eyes of the user 114 interacting with the interactive panel 116.

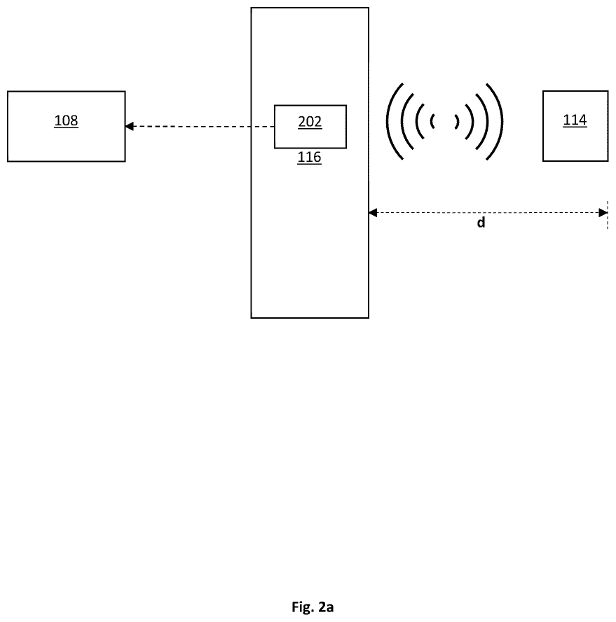

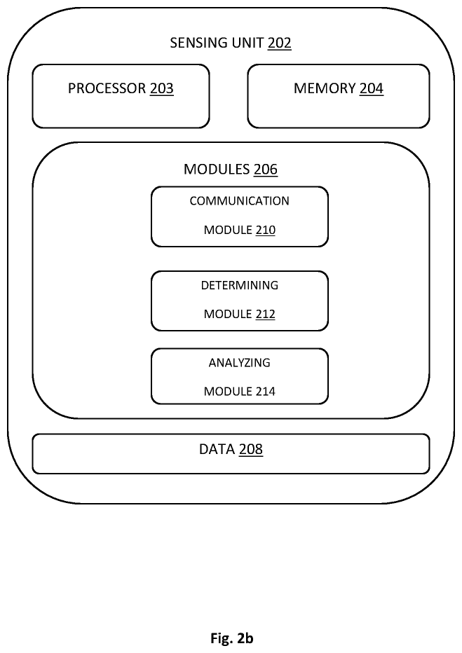

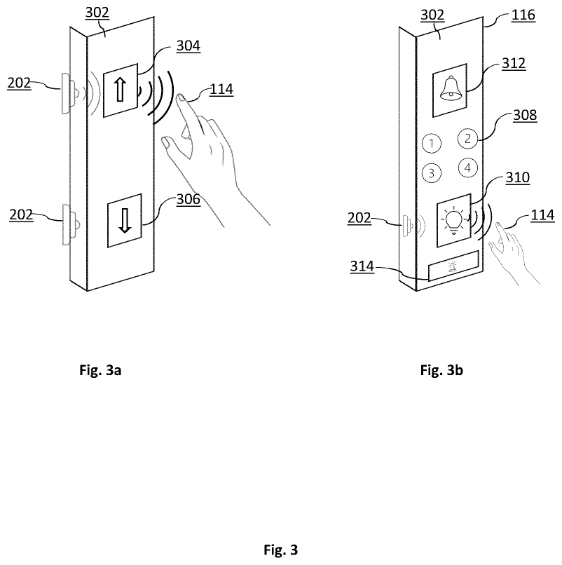

FIG. 2a illustrates a block diagram of the interactive panel 116 for the elevator unit 100, according to an embodiment of the present disclosure. FIG. 2b illustrates a block diagram of the at least one sensing unit 202 of the interactive panel 116, according to an embodiment of the present disclosure. FIGS. 3a and 3b illustrate an exemplary view of the LOP 116a and the COP 116b, respectively, according to an embodiment of the present disclosure. Referring to FIGS. 1-3b, in the illustrated embodiment, the elevator unit 100 may include the LOP 116a and the COP 116b. The user 114 may interact with the LOP 116a. Thus, the LOP 116a may be adapted to trigger the at least one call operation signal to perform the upward movement or the downward movement of the at least one elevator car 102. Similarly, the user 114 may interact with the COP 116b. The COP 116b may be adapted to trigger the at least one call operation signal to perform movement of the at least one elevator car 102 to a respective floor in the building.

It should be understood that the constructional and operational details of the LOP 116a and the COP 116b are similar to each other. Therefore, for sake of brevity, the constructional and operational details of the interactive panel 116 are explained with respect to only the LOP 116a. From hereinafter, the LOP 116a may interchangeably be referred to as the interactive panel 116, without departing from the scope of the present disclosure.

Constructional and operational details of the interactive panel 116 and the at least one sensing unit 202 are explained in detail in the subsequent sections of the present disclosure.

In an embodiment, the interactive panel 116 for the elevator unit 100 may include the at least one sensing unit 202. The at least one sensing unit 202 may be in communication with the controller 108 of the elevator unit 100. For an instance, the at least one sensing unit 202 may be arranged in the back-panel of the interactive panel 116 such that the at least one sensing unit 202 is not visible to the user 114. The interactive panel 116, including the back panel may be an optically opaque component. The interactive panel 116 may be adapted to house the at least one sensing unit 202 such that the user 114 is unable to view the at least one sensing unit 202 using the naked eyes. In one example, the interactive panel 116 may include one or more than one sensing unit 202, each for one or more control buttons of the interactive panel 116 for performing any associated function of the elevator unit 100. In an embodiment, the at least one sensing unit 202 may interchangeably be referred to as the sensing unit 202.

Referring to FIG. 2b, the sensing unit 202 may include, but is not limited to, a processor 203, memory 204, modules 206, and data 208. The modules 206 and the memory 204 may be coupled to the processor 203.

The processor 203 can be a single processing unit or several units, all of which could include multiple computing units. The processor 203 may be implemented as one or more microprocessors, microcomputers, microcontrollers, digital signal processors, central processing units, state machines, logic circuitries, and/or any devices that manipulate signals based on operational instructions. Among other capabilities, the processor 203 is adapted to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The modules 206, amongst other things, include routines, programs, objects, components, data structures, etc., which perform particular tasks or implement data types. The modules 206 may also be implemented as, signal processor(s), state machine(s), logic circuitries, and/or any other device or component that manipulate signals based on operational instructions.

Further, the modules 206 can be implemented in hardware, instructions executed by a processing unit, or by a combination thereof. The processing unit can comprise a computer, a processor, such as the processor 203, a state machine, a logic array, or any other suitable devices capable of processing instructions. The processing unit can be a general-purpose processor which executes instructions to cause the general-purpose processor to perform the required tasks or, the processing unit can be dedicated to performing the required functions. In another embodiment of the present disclosure, the modules 206 may be machine-readable instructions (software) which, when executed by a processor/processing unit, perform any of the described functionalities.

In an embodiment, the modules 206 may include a communication module 210, a determining module 212, and an analyzing module 214. The communication module 210, the determining module 212, and the analyzing module 214 may be in communication with each other. The data 208 serves, amongst other things, as a repository for storing data processed, received, and generated by one or more of the modules 206.

In an embodiment, the communication module 210 is configured to transmit a signal. For instance, the signal may be indicative of radio waves transmitted by the at least one sensing unit 202 in a form of a radiation pattern. The radiation pattern may be indicative of distribution of radiations or electromagnetic signals emitted in a direction.

Further, the communication module 210 is configured to detect a reflected signal. For instance, the reflected signal may be indicative of the radio waves reflected from the user 114. For instance, the user 114 may intend to call the at least one elevator car 102 on the respective floor where the user 114 is standing and may bring a body part of the user 114 such as hand, palm, or finger in a predefined distance range (d) of the at least one sensing unit 202. The presence of the body part within the predefined distance range (d) of the at least one sensing unit 202 may reflect the signal.

In an embodiment, the communication module 210 of the at least one sensing unit 202 is configured to detect the reflected signal from the foreign object within the predefined distance range (d). The signals reflected by the foreign object beyond the predefined distance range (d) may not be detected by the at least one sensing unit 202. The predefined distance range (d) may be stored in the memory 204 associated with the at least one sensing unit 202. For instance, the predefined distance range (d) is indicative of a region where the presence of the foreign object may be detected by the at least one sensing unit 202 as a result of the signals reflected by the foreign object. Thus, the communication module 210 of the at least one sensing unit 202 corresponding to at least one control button of the interactive panel 116 detects the reflected signal from the foreign object present in the predefined distance range (d) of the at least one sensing unit 202.

The detection of the reflected signal reflected from the foreign object may generate the interaction. Further, the interaction triggers at least one call operation signal to operate the elevator unit 100. The at least one call operation signal may be indicative of the instruction to perform the associated operation of the elevator unit 100. Further, the at least one call operation signal may be transmitted by the at least one sensing unit 202 to the controller 108 for performing the associated operation of the elevator unit 100.

For instance, the user 114 may position the foreign object within the predefined distance range (d) of the at least one sensing unit 202 thus causing the interaction. Now, such interaction caused due to the foreign object may not be desired and may lead to trigger at least one call operation signal which may be false. Thus, the at least one sensing unit 202 may be configured to reject the interaction generated by the reflected signal from the foreign object. The communication module 210 may be in communication with the determining module 212.

In an embodiment, the determining module 212 may be configured to determine a time duration for which the reflected signal is detected. Further, the determining module 212 of the at least one sensing unit 202 is configured to compare the determined time duration with a threshold time duration. The threshold time duration may be prestored in the memory 204 of the at least one sensing unit 202. In one example, the determining module 212 may be configured to determine the time duration for which the reflected signal is detected, is greater than the threshold time duration. The communication module 210 and the determining module 212 may be in communication with the analyzing module 214.

In an embodiment, the analyzing module 214 may be configured to reject the interaction generated by the reflected signal from the foreign object if the time duration for which the reflected signal is detected, is greater than the threshold time duration, as determined by the determining module 212. Thereby, the communication module 210 may be configured to terminate transmission of an undesired at least one call operation signal as the analyzing module 214 rejects the interaction.

In another example, the determining module 212 may be configured to determine that the time duration for which the reflected signal is detected is less than the threshold time duration. Thus, the analyzing module 214 may be configured to accept the interaction generated by the reflected signal. Thereby, the communication module 210 may be configured to trigger at least one call operation signal to the controller 108 for performing the associated operation of the elevator unit 100 upon acceptance of the interaction by the analyzing module 214.

In an embodiment, the determining module 212 may be configured to determine a travel time of the reflected signal. Accordingly, the determining module 212 may communicate to the analyzing module 214 to reject or accept the interaction. Further, the determining module 212 may be configured to determine a distance between the foreign object and the at least one sensing unit 202 based on the travel time of the reflected signal. Thus, the travel time may establish that the foreign object is constantly present at the predefined distance range (d). Further, the at least one sensing unit 202 monitors the travel time of the detected reflected signal, while the foreign object remains located at the determined distance for the determined time duration as mentioned earlier.

In an embodiment, the analyzing module 214 may be configured to reject the interaction generated by the reflected signal if the determined distance remains constant for the determined time duration.

In an embodiment, the determining module 212 may be configured to determine an intensity of the detected reflected signal. Accordingly, the determining module 212 may communicate to the analyzing module 214 to reject or accept the interaction. The determining module 212 may be configured to determine a size of the foreign object based on the determined intensity. Thus, if the intensity of the foreign object remains same, then the at least one sensing unit 202 may be configured to determine that the foreign object is constantly present at the predefined distance range (d).

Thereby, the analyzing module 214 may reject the interaction generated by the reflected signal if the determined size of the foreign object remains constant for the determined time duration.

FIG. 3a illustrates an exemplary view of the lift operating panel (LOP) 116a, according to an embodiment of the present disclosure. FIG. 3b illustrates an exemplary view of the cabin operating panel (COP) 116b, respectively, according to an embodiment of the present disclosure. Referring to FIGS. 1, 2, 3a-3b, the interactive panel 116 may include, but is not limited to, at least one detection plane 302. For instance, the at least one detection plane 302 may form a board panel, which may be affixed to a wall of the building or a wall of the elevator car 102. The at least one detection plane 302 may be disposed in front of the at least one sensing unit 202. For instance, the at least one detection plane 302 may be positioned on the wall of the building, thus covering the at least one sensing unit 202. In one example, the at least one sensing unit 202 may be a pulse coherent radar sensor which may be positioned behind the at least one detection plane 302. In one example, the user 114 may trigger the at least one call operation signal in response to physically contacting the at least one detection plane 302.

Further, the LOP 116a and the COP 116b may include a plurality of control buttons. In one instance, the LOP 116a may include, but is not limited to, an up-call detection plane 304 and a down-call detection plane 306. Each of the up-call detection plane 304 and the down-call detection plane 306 may have the at least one sensing unit 202 positioned behind each of the up-call detection plane 304 and the down-call detection plane 306.

In an embodiment, the at least one sensing unit 202 positioned behind the up-call detection plane 304 may be configured to detect the user 114 within the predefined distance range (d) of the at least one sensing unit 202 and trigger the at least one call operation signal to perform the upward movement of the elevator car 102 of the elevator unit 100.

Similarly, the at least one sensing unit 202 positioned behind the down-call detection plane 306 may be configured to detect the user 114 within the predefined distance range (d) of the down-call detection plane 306 and trigger the at least one call operation signal to perform the downward movement of the elevator car 102 of the elevator unit 100.

In one instance, the COP 116a may include, but not limited to, a floor detection plane 308, a light switch detection plane 310, an alarm button detection plane 312, and an emergency switch detection plane 314.

The at least one sensing unit 202 may be positioned behind each of the floor detection plane 308, the light switch detection plane 310, the alarm button detection plane 312, and the emergency switch detection plane 314. In one example, the at least one sensing unit 202 may detect the user 114 within the predefined distance range (d) of the at least one floor detection plane 308 and trigger the at least one call operation signal to perform movement of the elevator car 102 of the elevator unit 100 to a respective floor.

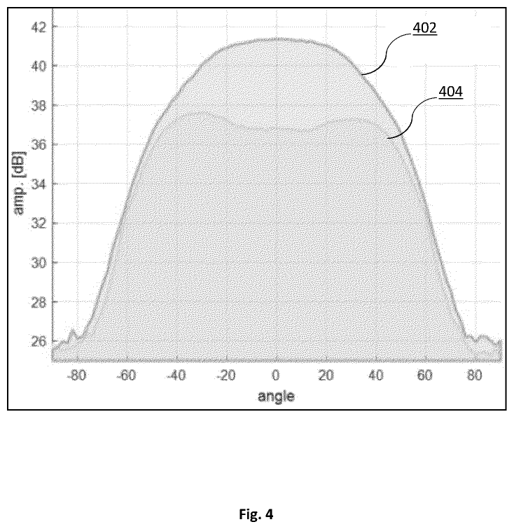

FIG. 4 illustrates an exemplary graphical representation of the radiation pattern of the transmitted signal by the interactive panel 116 of the elevator unit 100, according to an embodiment of the present disclosure.

In one example, a first curve 402 may indicate the radiation pattern of the reflected signal when the foreign material is not present within the predefined distance range (d) of the at least one sensing unit 202.

In one example, a second curve 404 may indicate the radiation pattern of the reflected signal when the foreign material is present within the predefined distance range (d) of the at least one sensing unit 202.

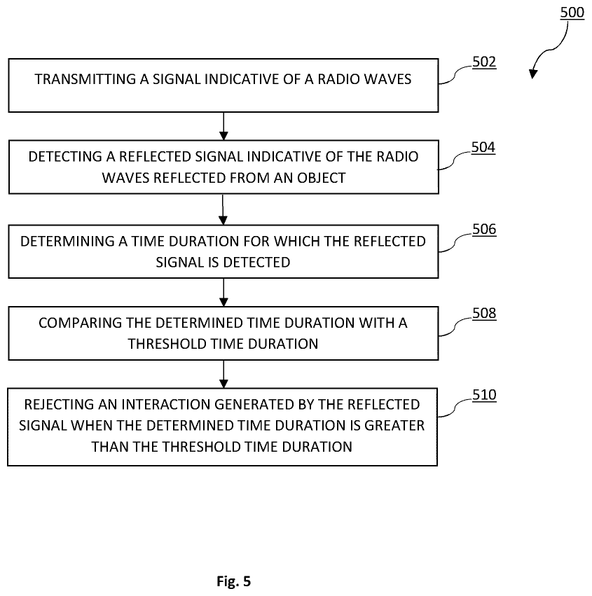

FIG. 5 illustrates a process flow of a method 500 for operating the interactive panel 116 adapted to detect the interaction indicating of triggering of at least one call operation signal to operate the elevator unit 100, according to an embodiment of the present disclosure. The method 500 may be a computer-implemented method executed, for example, by the at least one sensing unit 202 of the interactive panel 116. For the sake of brevity, constructional and operational features of the at least one sensing unit 202 that are already explained in the description of FIG. 1, FIG. 2, and FIG. 3a-3b are not explained in detail in the description of FIG. 5.

At block 502, the method 500 may include transmitting the signal, indicative of the radio waves.

At block 504, the method 500 may include detecting the reflected signal. The reflected signal is a consequence of the radio waves striking the foreign object and reflected back by the foreign object towards the at least one sensing unit 202. In one example, the foreign object may be present within the predefined distance range (d) of the at least one sensing unit 202 thus causing the at least one sensing unit 202 to detect the reflected signal.

At block 506, the method 500 may include determining the time duration for which the reflected signal is detected by the at least one sensing unit 202.

At block 508, the method 500 may include comparing the determined time duration with the threshold time duration by the at least one sensing unit 202.

At block 510, the method 500 may include rejecting the interaction generated by the reflected signal when the determined time duration is greater than the threshold time duration.

As would be gathered, the present invention provides the at least one sensing unit 202 to differentiate between a desired call operation signal and an undesired call operation signal. The at least one sensing unit 202 may be configured to adsorb the presence of the foreign object within its predefined distance range (d) as part of the environment and prevent from accepting any further interactions from the foreign object. Thus, the undesired call operation signal that may be continuously sent to the controller 108 for movement of the elevator car 102 may be prevented. Even if the user 114 intentionally or unintentionally permanently positions the foreign object within the predefined distance range, the radiation pattern corresponding to the reflected signal of the at least one sensing unit 202 may be updated. Such an update may result in accepting the foreign object as part of the environment and the radiation pattern is thus updated. Therefore, the foreign object may no longer be detected by the at least one sensing unit 202.

Therefore, the interactive panel 116 and the elevator unit 100 of the present invention is efficient, prevents false elevator call, cost-effective, and convenient.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1-15. (canceled)

16. An interactive panel for an elevator unit, comprising:
at least one sensing unit in communication with a controller of the elevator unit, wherein the at least one sensing unit is configured to:
transmit a signal, wherein the signal is indicative of one or more radio waves;
detect a reflected signal indicative of the one or more radio waves reflected from a foreign object;
determine a time duration for which the reflected signal is detected;
compare the determined time duration with a threshold time duration; and
reject an interaction generated by the reflected signal when the determined time duration is greater than the threshold time duration;
wherein to reject the interaction, the at least one sensing unit is further configured to:
determine a travel time of the reflected signal, wherein the travel time indicates a time elapsed in transmitting the signal and detecting the reflected signal;
determine a distance between the foreign object and the at least one sensing unit based on the determined travel time of the reflected signal;
monitor the travel time of the reflected signal, while the foreign object remains located at the determined distance for the determined time duration; and
reject the interaction generated by the reflected signal, if the determined distance remains constant for the determined time duration.

17. The interactive panel according to claim 16, wherein the at least one sensing unit is configured to detect the reflected signal while the foreign object remains within a predefined distance range of the at least one sensing unit.

18. The interactive panel according to claim 16, wherein to reject the interaction, the at least one sensing unit is further configured to:
determine an intensity of the detected reflected signal;
determine a size of the foreign object based on the determined intensity; and
reject the interaction generated by the reflected signal if the determined size of the foreign object remains constant for the determined time duration.

19. The interactive panel according to claim 16, wherein the at least one sensing unit is configured to:
accept the interaction generated by the reflected signal, if the determined time duration is less than the threshold time duration, wherein the interaction triggers at least one call operation signal indicative of an instruction to perform an associated operation of the elevator unit; and
transmit the at least one call operation signal to the controller for performing the associated operation of the elevator unit.

20. The interactive panel according to claim 19, wherein the interactive panel further comprises at least one detection plane disposed ahead of the at least one sensing unit and configured to trigger the at least one call operation signal in response to a user touching the at least one detection plane.

21. The interactive panel according to claim 16, wherein the at least one sensing unit includes a pulse coherent radar sensor.

22. The interactive panel according to claim 21, wherein the pulse coherent radar sensor is arranged in a back-panel of the interactive panel such that the at least one sensing unit is not visible to the user.

23. An elevator installation unit, comprising:
at least one elevator car coupled to at least one counterweight;
at least one guide rail for guiding the at least one elevator car within an elevator shaft of a building;
a controller for controlling a movement of the elevator car; and
at least one interactive panel, the at least one interactive panel comprising:
at least one sensing unit in communication with a controller of the elevator installation unit, wherein the at least one sensing unit is configured to:
transmit a signal, wherein the signal is indicative of one or more radio waves;
detect a reflected signal indicative of the one or more radio waves reflected from a foreign object;
determine a time duration for which the reflected signal is detected;
compare the determined time duration with a threshold time duration; and
reject an interaction generated by the reflected signal when the determined time duration is greater than the threshold time duration;
wherein to reject the interaction, the at least one sensing unit is further configured to:
determine a travel time of the reflected signal, wherein the travel time indicates a time elapsed in transmitting the signal and detecting the reflected signal;
determine a distance between the foreign object and the at least one sensing unit based on the determined travel time of the reflected signal;
monitor the travel time of the reflected signal, while the foreign object remains located at the determined distance for the determined time duration; and
reject the interaction generated by the reflected signal, if the determined distance remains constant for the determined time duration.

24. The elevator installation unit according to claim 23, wherein the at least one interactive panel includes at least one of a landing operating panel, and a cabin operating panel.

25. The elevator installation unit according to claim 24, wherein the landing operating panel comprises at least one of an up-call detection plane and a down-call detection plane.

26. The elevator installation unit according to claim 25, wherein the at least one sensing unit is configured to:
detect the foreign object within a predefined distance range of the up-call detection plane; and
trigger at least one call operation signal to perform an upward movement of the at least one elevator car of the elevator installation unit.

27. The elevator installation unit according to claim 25, wherein the at least one sensing unit is configured to:
detect the foreign object within a predefined distance range of the down-call detection plane; and
trigger at least one call operation signal to perform a downward movement of the at least one elevator car of the elevator installation unit.

28. The elevator installation unit according to claim 24, wherein the cabin operating panel comprises at least one of a floor detection plane, a light switch detection plane, an alarm button detection plane, and an emergency switch detection plane.

29. The elevator installation unit according to claim 28, wherein the at least one sensing unit is configured to:
detect the foreign object within a predefined distance range of the at least one floor detection plane; and
trigger at least one call operation signal to perform movement of the at least one elevator car of the elevator installation unit to a respective floor.

30. A method for operating an interactive panel, the method comprising:
providing the elevator unit, the elevator unit comprising:
at least one elevator car coupled to at least one counterweight;
at least one guide rail for guiding the at least one elevator car within an elevator shaft of a building;
a controller for controlling a movement of the elevator car; and
the interactive panel, the interactive panel comprising:
at least one sensing unit in communication with a controller of the elevator unit.
transmitting a signal, wherein the signal is indicative of one or more radio waves;
detecting a reflected signal indicative of the radio waves reflected from a foreign object;
determining a time duration for which the reflected signal is detected;
comparing the determined time duration with a threshold time duration; and
rejecting an interaction generated by the reflected signal when the determined time duration is greater than the threshold time duration.
